(19) United States
(12) Patent Application Publication
(10) Pub. No.: US 2006/0275829 A1
(43) Pub. Date: Dec. 7, 2006

(54) Combinatorial library for proteomic investigations

(76) Inventors: David J. Hammond, Laytonsville, MD (US); Julia Tait Lathrop, Falls Church, VA (US)

Correspondence Address: MERCHANT & GOULD PC, P.O. BOX 2903, MINNEAPOLIS, MN, 55402-0903, US

(21) Appl. No.: 11/454,800

(22) Filed: Jun. 19, 2006

Related U.S. Application Data
(63) Continuation-in-part of application No. 10/414,523, filed on Apr. 14, 2003.
(63) Continuation-in-part of application No. 10/601,032, filed on Jun. 20, 2003.
(60) Provisional application No. 60/372,091, filed on Apr. 15, 2002.
(60) Provisional application No. 60/395,038, filed on Jul. 11, 2002.

(51) Int. Cl. C40B 30/06; C40B 40/10

(52) U.S. Cl. 435/7.1

(57) ABSTRACT

The present invention relates to solid-phase combinatorial peptide libraries synthesized on chromatography beads and their use to prepare samples for proteomic investigations.

### CROSS REFERENCE TO RELATED CASES

This application is a continuation-in-part of U.S. patent application Ser. No. 10/414,523, filed Apr. 14, 2003, which claims priority to U.S. Provisional Patent Application Ser. No. 60/372,091, filed Apr. 15, 2002, the contents of each of which are incorporated by reference herein in their entirety. This application is also a continuation-in-part of U.S. patent application Ser. No. 10/601,032, filed Jun. 20, 2003, which claims priority to U.S. Provisional Application Ser. No. 60/395,038, filed Jul. 11, 2002, the contents of each of which are also incorporated by reference herein in their entirety.

### BACKGROUND

1. Field of the Invention

The field relates to solid-phase combinatorial peptide libraries synthesized on chromatography beads and their use to prepare samples for proteomic investigations.

2. Background to the Invention

Proteomics seeks to identify and characterize multiple proteins simultaneously. Investigation of whole blood is highly desirable, but is complicated by having multiple proteomes, e.g. red blood cells, platelets, macrophages and plasma. Thus, it is usually fractionated by centrifugation into red blood cell concentrates, buffy coat and plasma prior to analysis of the plasma component. Blood plasma and serum fractions are the primary specimens for analysis of existing and discovery of new biomarkers and disease diagnostics as they comprise the largest and deepest version of the human proteome, spanning 10¹⁰ or more orders of magnitude of concentration of various targets. The number of proteins present is immense, particularly when considering post-translational micro-heterogeneity, variations in glycosylation, proteolytic fragmentation, and the antibody repertoire, which alone may comprise 10,000,000 different proteins. These attributes also make plasma and serum particularly difficult to analyze, and prevent most analysis of whole blood.

The enormous depth in concentration and complexity reflects the dynamic range (difference between the highest and lowest concentration) (Lathrop et al., Expert Review of Proteomics 2(3):393-406 (2005)), Anderson (J. Physiol. 563(1):23-60 (2005), Topical review Candidate-based proteomics in the search for biomarkers of cardiovascular disease), and Anderson N. L. and Anderson, N. G, (“The human plasma proteome, History, Character and diagnostic prospects,” Molecular and Cellular Proteomics 1(11): 845-867 (2002)). The concentration of albumin is about 40 mg/ml of plasma while cytokines such as IL-6 are present at ˜1-10 pg/ml or lower; however, current technology, i.e. mass spectrometry and 2-dimensional gel electrophoresis is limited to detecting a dynamic range in protein concentration of 10³-10⁴. Consequently, to identify trace components it is necessary to selectively enrich trace components over many orders of magnitude.

There are a number of approaches for selective enrichment of trace entities, especially proteins. Proteins may be digested by proteases, especially trypsin. The resulting peptides may then be fractionated by multi-dimensional chromatography prior to analysis by tandem mass spectrometry, i.e. MudPIT. Alternatively, the proteins themselves may be fractionated by chromatography, e.g. ion exchange, reverse phase, metal chelate, gel filtration, and protein-specific or group-specific affinity separation prior to analysis. See Lee, W-C and Lee K H, “Applications of affinity chromatography in proteomics,” Analytical Biochemistry 324:1-10 (2004), for a review on affinity depletion, metal chelate affinity for enrichment of group specific proteins. See Shi, Y., Xiang R., Horvath C., and Wilkins J A “The role of liquid chromatography in proteomics,” J. Chromatography A 1053:27-36 (2004) for a more general review of other forms of chromatography in proteomics.

An additional approach is to selectively deplete the abundant proteins by use of specific monoclonal antibody affinity columns. Selective depletion strategies are most often targeted to albumin, IgG, IgA, transferrin, haptoglobin, alpha-1 proteinase inhibitor (API) also known as antitrypsin, alpha-2 macroglobulin and fibrinogen. These monoclonal affinity columns are expensive, and seldom totally specific for their target; furthermore, they only decrease the concentration range by a couple of orders of magnitude, leaving the trace proteins still below the limits of detection and still masked by the next set of most abundant proteins. Such products are available from Agilent Technologies' multi affinity removal system (“MARS”), Genway Biotech's “Seppro” and Sigma-Aldrich's ProteoPrep 20 immunodepletion Kit.

Thus, the above strategies will fractionate major abundant species away from trace components, but all have significant disadvantages including instability of the sample in the absence of the abundant proteins, and trace components are usually further diluted during sample preparation and processing. Moreover, many trace targets may bind to the abundant species, especially albumin, antibodies, for example IgG, IgA and IgM, fibrinogen and alpha-2 macroglobulin, and thereby may be even further depleted during fractionation. Furthermore, the methodologies, especially monoclonal antibody-based depletion, are specific for the proteins in an individual tissue from a single, or closely related, species. Finally, the immunoglobulins, which are among the most valuable classes of proteins as biomarkers of infection and as therapeutics, are frequently removed and generally are unavailable for evaluation.

Within whole blood there exist several protein proteomes, e.g. red blood cell, monocyte, lymphocyte, granulocyte, macrophage and the soluble or plasma proteins. The plasma proteome is considered to be the most valuable since it contains, in addition to standard plasma proteins, e.g. of the complement and coagulation cascades, leakage proteins and microparticles from damaged cells that may be important indicators (biomarker) of disease. Preparation of plasma requires centrifugation of whole blood or plasmapheresis; however, this processing can activate proteases and generate artifacts unrelated to the actual physiological state of unprocessed whole blood. Because of the above limitations, it is preferred to minimize the time and manipulation of the blood sample and to avoid lysing significant amounts of cells, especially red blood cells, which results in the liberation of high levels of hemoglobin. Similarly, it is important to prevent the activation of platelets, which would produce a wide variety of cytokines and growth factors. Furthermore, the processing of blood or plasma should not activate complement or coagulation factors, all of which will result in significant changes in the state of plasma proteins. Finally, it is desirable to concentrate the trace components and decrease the abundant components, yet maintain concentration differentials in individual analytes between comparable samples.

Thus, there remains an unmet need to bind rapidly targets from complex mixtures such as blood in a manner that preserves the starting composition of the sample without detrimental activation of the components. Several polystyrene-based peptide synthesis resins have been rendered hydrophilic and adapted for combinatorial chemistry and ligand screening. Peptide libraries synthesized on TentaGel have been described by Furka as extended by Lam et al. Furka et al., Int. J. Peptide Protein Res., 37:487-493 (1991); Lam et al., Nature, 354:82-84 (1991). Lam et al. has been used to identify ligands that bind multiple targets (Hammond, WO 01/40265). However, TentaGel is not porous to large proteins and has relatively poor protein-binding capacity (see U.S. patent application Ser. No. 11/089,128, to Boschetti and Hammond). An alternative resin called “CLEAR” (Cross-Linked Ethoxylate Acrylate Resin) was synthesized by Kempe and Barany (“CLEAR: A novel family of highly cross-linked polymeric supports for solid-phase peptide synthesis,” J. Am. Chem. Soc. 118: 7083-7093 (1996)) and incorporated a variety of methacrylate monomers through radical copolymerization with the branched cross-linker trimethylolpropane ethoxylate triacrylate as an alternative to other standard peptide synthesis supports (polystyrene, Pepsyn K, Polyhipe, PEG-PS, TentaGel and PEGA). The function for this resin is peptide synthesis and, being highly cross-linked, would not be expected to be macroporous, with high capacity and selective binding of proteins. In contrast, the supports used in this invention are macroporous and have high capacity for binding protein targets. Moreover, unlike “TentaGel”—based libraries, these can be used directly with whole blood and plasma (see U.S. patent application Ser. Nos. 10/414,523, 10/601,032, 10/823,888 and 10/727,335; Thulasiraman V. et al., Electrophoresis 2005, 3561-3571, Reduction of the concentration difference of proteins in biological liquids using a library of combinatorial ligands).

Buettner et al originally selected chelate resin from TosoHaas (Buettner et al., Int. J. Peptide and Protein Res. 70-83 (1996)) to decrease non-specific binding of proteins and to facilitate ligand-scale up for large-scale chromatography using ligands identified by screening combinatorial libraries. Chelate resins, as the basis for synthesizing a peptide library, have some major limitations. First, it is necessary to couple an amino group to the resin for Fmoc and tBoc peptide synthesis. This was accomplished by Buettner et al (Buettner et al., Int. J. Peptide and Protein Res. 70-83 (1996); using ethylenediamine in a slight molar excess of benzotriazole-1-yloxytrispyrrolidino-phosphonium hexfluorophosphate (PyBOB) and N-methylmorpholine. While amidation of the resin was accomplished, the degree of free amino groups is difficult to control because a molecule of ethylenediamine can react with two adjacent carboxy groups, resulting in cross-linking of the surface and rendering neither amine of the ethylene diamine accessible for peptide synthesis. Moreover, non-reacted carboxy groups provide a negatively charged surface that can be detrimental to the study of blood proteins, as these surfaces are known to activate blood proteins such as bradykinin. Nevertheless, some qualities of the chelate backbone resin polymer are beneficial for library production, especially their low levels of non-specific binding and their ability to be used directly with plasma (see Kaufman, D. B. et al 2002, Biotechnology and Bioengineering 77, 278-289, Affinity purification of fibrinogen using a ligand from a peptide library) as a method to identify ligands to known proteins; however, it has neither been used for purification of proteins from whole blood, nor for proteomic investigations. We elected to use a different base polymer resin, AF Amino 650M from Tosoh Bioscience, for the following reasons:
It supports peptide synthesis in an organic environment.
It is commercially available with an amino group for direct peptide synthesis.
It has been custom synthesized in different sizes (10 to 300 μm), and yet can be powdered to provide high diversity in a small mass of library.
It binds plasma proteins directly from whole blood
The porosity of the beads (100 nm) prevents blood cell components from perfusing the library.
It does not activate platelets, complement or factor VII.
It may be easily lyophilized for long term storage
It may be autoclaved for sterility for use in sterile environments

The surface density of the amino acids was controlled by adding a mixture of Fmoc- and tBoc-alanine to the resin. The tBoc groups were removed by trifluoroacetic acid (TFA), remaining reactive groups were acetylated, the Fmoc groups were deprotected with piperidine and ligand synthesis proceeded by addition of Fmoc-protected amino acids. We synthesized the ligands on an epsilon amino caproic acid spacer to separate the library from the surface of the resin. We synthesized a library of peptides comprising 6 amino acids, which we found provided sufficient size and diversity to identify ligands to a vast array of different targets. The N-terminal amino acid was a D-isomer which protects against digestion with amino-peptidases that may be present in the sample. The unnatural amino acid 2′-naphthylalanine was included to improve diversity within the library by increasing the variety of ligands and to provide a more stable chemical complement to the use of tryptophan alone.

### SUMMARY OF THE INVENTION

The invention provides a significant improvement in the use of combinatorial peptide library synthesis for use in proteomic investigations. The library uses an inert base resin Toyopearl AF 650 M amino from Tosoh Bioscience (formally TosoHaas). The library is synthesized onto the resin through an alanine linked to an epsilon amino caproic acid. The combinatorial library of ligands comprising 2-15 amino acids contains all the natural amino acids except Cys and Met, but includes the unnatural amino acid 2′naphthylalanine in the next five positions. The N-terminal amino acid is a D-isomer of the aforementioned amino acids except glutamine, which was not included in this position due to its tendency to cyclize at the N-terminal. The overall density of ligands was adjusted to a 3:1 ratio using a mixture of tBoc to Fmoc alanine.

The combinatorial library has demonstrated a unique set of capabilities including the ability to simultaneously bind and enrich trace plasma proteins and pathogens directly from whole blood in a simple, robust operation. The uses of the library include the concentration and identification of individual proteins from complex mixtures, such as whole blood, plasma and cell culture supernatants, compression of the concentration range of proteins, and identification of novel activities based on functional screening.

### BRIEF DESCRIPTION OF THE FIGURES

FIG. 1. Regular FIoNA library versus Acetylated library. Lane 1, molecular weight marker. Lane 2, untreated plasma. Lane 3, proteins eluted from regular FIoNA library. Lane 4, proteins eluted from acetylated FIoNA library.

FIG. 2. Electrophoretic elution of protein from library. Lane 1, molecular weight marker. Lane 2, starting material. Lane 3, proteins eluted by low pH from beads that previously had been eluted by low pH. Lane 4, proteins eluted from beads loaded directly into the well of the gel. Lane 5, starting material.

FIG. 3. Treatment of serum with sonicated beads. Lane 1, molecular weight marker. Lane 2, starting, untreated plasma. Lane 3, unbound (flow through) material from whole bead sample. Lane 4, unbound (flow through) material from sonicated bead sample. Lanes 5 and 6, washes from whole bead and sonicated bead samples, respectively. Lane 7, proteins eluted from whole bead sample. Lane 8, proteins eluted from sonicated bead sample. Lane 10, molecular weight marker.

### DETAILED DESCRIPTION OF THE INVENTION

The invention provides a solid-phase combinatorial peptide library synthesized on an inert macroporous support to detect a plethora of target molecules, following separation from complex samples including whole blood in an amount which is a function of their concentration in the starting material, e.g. blood. In particular, the invention provides a simple-to-use solid phase combinatorial library useful for characterizing targets that binds to ligands. The library is synthesized on a resin bead, such as a Toyopearl AF 650 M Amino from Tosoh Bioscience, and contains a spacer (epsilon amino caproic acid) at the carboxy terminal, an alanine for adjusting the concentration of ligand, a 5 amino acid sequence comprising equimolar amounts of the natural L-amino acids with the exclusion of cysteine and methionine, but with the inclusion of 2-naphylalanine and an N-terminal amino acid comprising D isomers of these amino acids with the exception of glutamine, which has the potential to cyclize to 2-pyrrolidone-5-carboxylic acid and to pyroglutamate (5-oxoprine) and pyroglutamyl residues by enzymatic and/or chemical (particularly acid) conditions. The density of ligands is 50 to 400 μmole per gram dry weight of resin, and preferably 100 μmole per gram dry weight.

The libraries may be further modified by inclusion of additional or alternative amino acids such as amino-dipic acid, beta-alanine, 2-aminobutyric acid, 6-amino caproic acid, citrulline, hydroxylysine, N-methylvaline, and norleucine incorporated into the synthesis, chemical modification after synthesis, or biochemical modification of the ligands themselves.

The libraries may be used by (i) providing one thousand or more ligand-bead complexes, (ii) contacting the ligand-bead complexes with a sample comprising targets under conditions that allow at least one target to bind to at least one ligand-bead complex, thereby forming one or more target-ligand bead complexes, (iii) removing the non-bound material. The targets can then be characterized as described in U.S. patent application Ser. Nos. 10/414,523, 10/601,032, 10/823,888, 10/727,335, 10/414,524, and 11/089,128, and Thulasiraman et al. (Electrophoresis 26(18):3561-3571 (2005)).

Although the preferred embodiment uses one thousand or more different ligands to produce one thousand or more ligand-support complexes, one of skill in the art could envision the use of fewer ligands. The amount of ligands used, or course, will depend on the complexity of the sample being characterized. Although most samples to be characterized are complex enough to require one thousand or more ligand-support complexes, some may only require 900, 800, 700, 600, 500, 400, 300, 200, 100 or fewer. Furthermore, as many as five thousand, ten thousand, fifty thousand, one hundred thousand, five hundred thousand, one million or more different ligand-support complexes can be used in the methods of the claimed invention.

A number of acrylates and polyhydroxymethacrylates have been evaluated for combinatorial peptide synthesis. Buettner et al originally selected chelate resin from TosoHaas (1) to decrease non-specific binding of proteins to facilitate large scale purification of proteins using ligands identified by screening combinatorial libraries; however, this resin has some limitations as the backbone of a ligand library. First, it is necessary to couple an amino group to the resin prior to performing either tBoc- or Fmoc-based peptide synthesis. This was accomplished by Buettner et al using ethylenediamine in a slight molar excess of benzotriazole-1-yloxytrispyrrolidino-phosphonium hexafluorophosphate (PyBOB) and N-methylmorpholine. Amidation of the resin was accomplished through free amino groups on the conjugated ethylene diamine. However, it is difficult to control the level of free amine because the ethylenediamine can react with two adjacent carboxy groups on the resin resulting in cross-linking of the surface and rendering neither amine accessible for peptide synthesis. Moreover, non-reacted carboxy groups provide a negatively-charged surface that can activate blood proteins such as bradykinin Cyr M., Eastlund, T., Blais, C. Roleau, J. L., Adam, A. Bradykinin metabolism and hypotensive reaction (2001) Transfusion 41: 136-150?). The resin polymer does have qualities that make it appropriate for libraries including limited non-specific binding and the ability to be used directly with plasma (Thulasiraman, V., et al., Electrophoresis 26(18):3561-3571 (2005)). In addition, it has not been evaluated for the ability to bind targets such as trace proteins from whole blood, nor has the base polymer been found to be compatible with cellular functions.

Compounds included in the base polymer are methacrylate and hydroxymethacrylates including glycidol methacrylate, ethylene glycol dimethacrylate, pentaerytritol dimethacrylate, dimethacrylate and 2-aminoethyl methacrylate, polyethylene glycol-400 dimethacrylate, polyethylene glycol ethyl ether methacrylate, and trimethylolpropane trimethacrylate. Other compounds that may be added include polyethylene oxides, polyethylene glycol, and short chain hydrocarbon-oxide spacers leading to —CH₂—CHOH—CH₂—NH₃, polysaccharide derivatives of any of the foregoing, and combinations of the foregoing. Examples include Toyopearl AF-Amino 650M from Tosoh Bioscience, fractogel EMD Amino (M) from MerckKGaA in Darmstadt, Germany, and Affi-Prep and MacroPrep media from Bio-Rad The resins possess sufficient concentration of functionalized groups for the chemical synthesis of combinatorial libraries by the split, couple and recombine method of Furka et al. as extended by Lam et al. (Furka, A. et al., Int. J. Peptide Protein Res. 37:487-493 (1991); and Lam, K. S., et al., Nature 354:82-84 (1991); see also Lam et al. WO 92/00091.

Chemical, Biological and Biochemical Inert Base Material

The 650 amino resin by Tosoh Bioscience is inert to organic solvents used in peptide synthesis and is resistant to degradation over a broad range of pHs, though the peptide ligands and base polymer may degrade after prolonged exposure to alkali conditions. The amine is used for attachment of the linkers such as epsilon amino caproic acid and methionine, while the free hydroxyl groups of the methacrylates and linkers, e.g. polyethylene oxides, polyethylene glycols, provide the necessary hydrophilicity for use with biological materials. Cells can grow on and around the beads without any obvious effects such as cell death. Examples of such cells include human T-cell lymphoma NK92, melanoma cell lines, human liver line HEPG2 and even whole organisms, e.g. hookworms. In addition, the base resin has been shown to be inert to platelet activation, activation of coagulation factors and complement, and does not cause lysis of red blood cells. Moreover, the base matrix has low non-specific binding of the most abundant blood proteins, hemoglobin, albumin and immunoglobulins.

The beads can be sterilized by several methods including autoclaving at 125° C. or by washing with organic solvents. The beads may be preferably stored dry or, for short durations, in alcohol, e.g. 20% ethanol.

An advantage of the targets being immobilized as target-ligand-support complexes is that binding helps stabilize the structure of some targets, see U.S. Pat. No. 5,786,458 to Baumbach et al. The '458 patent provides rationale, examples and references exploiting this property for improved and specific viral inactivation of therapeutic proteins. The same general principles hold true for the stabilization of multiple targets bound to the multiple ligands of this invention.

Yet another advantage of the invention is that the biological, biochemical, and chemical activity of the target can be maintained if desired by carefully selecting the elution conditions. Conditions can be advantageously controlled to elute a subpopulation of the bound target at any one time, and to identify specific elution conditions of selected targets. Moreover, it is also possible to identify targets that bind to specific molecules by using an elution buffer containing that specified molecule or conjugate of that molecule (see U.S. patent application Ser. No. 10/601,032).

Uses of the Combinatorial Library

Combinatorial libraries of the invention have been successfully used in a method for detecting ligands and targets in a mixture (U.S. patent application Ser. No. 10/601,032). Examples of this technology demonstrate that the beads can be used for identification of ligands for predetermined proteins, characterization of proteins based on a biochemical activity, identification of ligands that were found to elute the target under different conditions, and identification of proteins involved in a disease state. In addition, multiple proteins and protein complexes that are bound to the ligands on the beads can be identified.

The combinatorial libraries have been used in U.S. patent application Ser. No. 10/414,523 to screen for cytokine factors in conditioned cell medium and plasma, for growth factors and enzyme activities (phosphatases and organophosphatases), and for antibodies specific to a cell type, e.g. antibodies that kill melanoma cells They also have been used to reduce the range in concentrations of analyte species in a sample (U.S. patent application Ser. No. 11/089,128) with such samples including plasma, IgG-depleted plasma, and serum.

Combinatorial libraries of this invention have been used to identify structural isomers of targets, namely the normal prion protein PrPc and the conformationally distinct form PrPsc (Hammond et al, 2004, “Method for identifying ligands specific for structural isoforms of proteins,” PCT/US04/11402).

The library is suitable for fractionating plasma proteins from whole blood. Currently, blood samples are usually centrifuged to obtain plasma proteins for analysis. This is time consuming, expensive and often impractical for preparation of samples for point of care diagnosis. Furthermore, the length of processing time allows for activation of plasma proteases, and can generate proteolytic fragments that may vary between samples, but are unrelated to the physiological state of the sample when obtained. Alternatively, serum formation from blood is frequently used to prepare samples for analysis. This procedure involves activation of a number of proteins of the coagulation cascade to form a clot and separation of the clot which primarily contains fibrin, other plasma proteins, red blood cells, and platelets from the non-clotted “serum” proteins. During clot formation, analytes in plasma may be degraded by the activated coagulation enzymes and may also be sequestered into the clot, excluding them from subsequent analysis. Serum and whole blood frequently have high levels of soluble hemoglobin as a result of red blood cell lysis, possibly due to the collection conditions, which interferes with many analytical assays. The method of the invention uses whole blood without the need for pre-fractionation, thereby saving time and manipulation, and capturing the targets as close to their physiological state as possible.

In a preferred embodiment, the combinatorial library is added to whole blood and the targets are plasma-derived proteins. Whole blood requires the presence of anticoagulants to prevent coagulation over time. Preferred anticoagulants include EDTA, citrate, heparin, and protease inhibitors such as aprotinin, D-phenylalanyl-L-prolyl-L-arginine chloromethyl ketone (PPACK), etc. The preferred contact time between blood and combinatorial library is kept as short as possible to prevent undue protein modification over time. A contact time≦15 mins is preferred with other times ranging up to 24 hours. The preferred ratio of combinatorial library to whole blood may be in the order of 1:5 to 1:10 to 1:100 to 1:1,000 or more.

Thus, the inventive method will simultaneously bind and concentrate trace plasma proteins from blood without the need for generation of plasma through centrifugation or serum collection. Furthermore, it will decrease the concentration of the majority of abundant species, including whole cells and abundant proteins such as albumin and transferrin, while immobilizing and stabilizing the analytes on the ligands. This immobilization will physically restrict the ability for proteins, especially proteases, to freely diffuse into solution where they will interact with and potentially degrade important biomarkers on other target-ligand-support complexes. In addition, since the immobilization of proteins will stabilize some targets' conformational structure as target-ligand-support-complexes, the ability to evaluate biochemical and biological properties of the bound targets are improved.

Conventionally, plasma or serum are often further fractionated to improve the sensitivity of detection of the trace proteins. This can be achieved by selectively depleting the abundant proteins using monoclonal affinity columns directed against the most abundant proteins, fractionation using chromatography chips or columns (ion exchange, hydrophobic, metal chelate, etc.) or may be achieved following digestion of the proteins by trypsin and separation of the resulting peptides using 2-D liquid chromatography followed by tandem mass spectroscopy. All of these strategies have significant advantages and disadvantages. The greatest disadvantages are time, cost, losses and dilution of trace targets during manipulation of the plasma or serum sample, and sample instability at low analyte, especially albumin, concentrations.

This inventive method overcomes many of these disadvantages by concentrating trace plasma targets from blood samples on the beads. Moreover, in general, trace analytes are preferentially enriched relative to more abundant species as a percentage of total protein bound, making the detection of proteins preferentially expressed in a disease state at low levels easier to identify. In addition, because all the components within a sample can be captured on different beads (ligand-support-complexes), the beads may be assayed in total, sequentially or simultaneously, for the presence of multiple, independent targets; may be split into a number of different sub-pools; or the individual beads may be evaluated for the presence of targets. Furthermore, the amount of an individual target bound from one sample is a function of its concentration in that sample relative to a comparable sample, such that more of a target is bound from a mixture with a higher initial concentration of that target than is bound from a mixture with a lower initial concentration of that target.

Methods of Use

Large scale synthesis of a specific affinity resin may be achieved by using the exact same synthesis route as taken for the library except that only one, defined amino acid is incorporated at each step of the synthesis instead of using a host of amino acids for the split, couple and recombine method of library generation.

The same library may be added to the sample in either a batch or a column mode depending on the final application. Washing of non-bound material may also be accomplished in batch or column format. Moreover, the contact of the material with the library may be accomplished in one format and washing performed in another. Several examples, for example of batch binding followed by column washing, are provided in (U.S. patent application Ser. Nos. 10/414,523 and 10/601,032; U.S. patent application entitled “Recovery of Analytes Using Combinatorial Libraries,” to Hammond and Lathrop, filed on the same date as this application; and U.S. patent application entitled “Identification and Characterization of Analytes from Whole Blood,” to Hammond and Lathrop, filed on the same date as this application).

Sequestering of the Highly Interactive Binding Targets

A further option of the method of this invention is to concentrate the plasma proteins on the beads in combination with decreasing the concentration of the most efficiently bound proteins, e.g. fibrinogen and lipoproteins such as LDL and HDL. The amount of any one analyte bound to a combinatorial library varies significantly. For example, fibrinogen, and HDL have a high incidence of high affinity ligands, perhaps due to such features as stronger and more effective binding through multi-point attachment of the ligands on individual beads to identical subunits on the target. In addition, different subunits may bind to different ligands, increasing the number of possible interactions while each subunit may have multiple binding sites. Furthermore, proteins such as fibrinogen exist in protein complexes, and binding of the complex may be mediated by any one member of the complex. Fibrinogen itself is comprised of six subunits and, itself, binds many other target proteins, including fibronectin, factor XIII, thrombin, von Willebrand factor. HDL contains paraoxonase, apolipoprotein (apo) A1, apo AII, apo IV, apo B100, apo D, apo E and other proteins. In contrast, transferrin and A1PI that have a low frequency of high affinity ligands circulate in the blood as monomers with very few binding interactions with other proteins and binding sites.

Affinity resins specific to proteins that preferentially bind to a library, e.g. fibrinogen, may be included in a compartment separated from the library by a dialysis membrane to further enrich for binding of the trace targets. The advantages of performing simultaneous co-incubation of library and specific affinity ligands instead of conventional depletion strategies is that entities binding to the major species can still be captured on the library beads (ligand-support-complexes) without being almost completely lost to the bound, highly interactive species. In addition, a proportion of these interactive proteins will remain in solution to bind to high affinity binding sites within the library and will still be analyzed, albeit at a lower overall concentration. Several high affinity resins specific for different antibodies may be included in the same compartment. A convenient method for finding ligands present in the combinatorial library of this invention is taught in (see U.S. patent application Ser. No. 10/414,523).

Thus, the invention further teaches that the resin of this invention many be used to study the composition of plasma targets within blood with minimal manipulation over a very broad range of target concentrations and the amount of bound protein is a function of the amount of free plasma derived analyte in the starting sample. Moreover, the degree of competition for binding may be modulated by reduction in the free concentration of abundant targets by simultaneous co-incubation of library and high affinity ligands to the abundant targets.

Resin Support

One criterion for selecting a base polymer for use as the support for synthesizing the ligand-support complexes is that it must be chemically, biochemically and biologically inert. Preferred supports are resin beads comprising a material selected from the group consisting of agarose, cellulose, dextran, ethylene glycol, fluoropolymers, polyacrylate, polyesters, polyethylene glycol, methacrylate and hydroxymethacrylates including glycidol methacrylate, ethylene glycol dimethacrylate, pentaerytritol dimethacrylate, dimethacrylate, and methacrylate monomer, polypropylene, polyethylene oxides, polysaccharide derivatives of any of the foregoing, and combinations of the foregoing. A particularly preferred support material is a polyhydroxylated methacrylate polymer. Examples of such resins include Toyopearl AF-Amino 650M from Tosoh Bioscience, fractogel EMD Amino (M) from MerckKGaA in Darmstadt, Germany, and Affi-Prep and MacroPrep media from Bio-Rad. The resin should also possess a sufficient concentration of functionalized groups for the chemical synthesis of combinatorial libraries by the split, couple and recombine method of Furka et al. (Furka et al., Int. J. Peptide Protein Res. 37:487-493 (1991)) as extended by Lam et al. (Lam et al., Nature 354:82-84 (1991)). The base resin must not activate platelets, coagulation factors, or complement and has very low non-specific binding to albumin and IgGs, and has no significant effect on the cell lines selected for evaluation.

Preferably, the support is a macroporous resin bead which allows large molecular weight proteins to readily permeate the bead. A suitable pore size is 100 nm (1,000 Angstroms), which allows most proteins and some viruses, but not cells, to enter the pores. Larger porosity may be desired for selective targeting of viruses or very large proteins and protein complexes. The beads may be about 300 μm or more in diameter. Such large beads possess high capacity which is useful in the analysis of the protein bound to individual beads and for column chromatography in samples with large particles including debris or cells. 65 μm diameter beads are useful for studies with whole blood and plasma proteins. Beads of 10 μm or less may be used in microfluidic formats. In a preferred embodiment, the beads are 1 μm or less. In addition, beads may also be reduced to a powder following combinatorial synthesis to provide greater diversity in a very small volume. This is desirable when preparing samples for analyses of protein profiles. The samples may also be milled to a fine powder or may be rendered magnetic by cross-linking the polymethacrylate beads to magnetic beads. Small ˜1 μm amino, carboxy or epoxy-beads are available from Dynal Biotech and Pierce. These may be crosslinked to appropriate functional groups on the resin, e.g. the terminal amino group.

Frequently, the amount of sample available for investigation is very limited. Consequently, the capacity of the bead for protein should be high to allow minimal volumes of beads to be used per unit volume of sample which will limit the dilution of blood with solvents or water of hydration associated with the beads. The capacity of the resins used in this invention are about 10 mg/ml for plasma, though the surface capacity of the beads themselves are 30 sq. meters per gram dry weight of resin, providing an optimal capacity of over 20 mg/ml.

Ligands

For purposes of the invention, the term “ligand” as used herein refers to any biological, chemical, or biochemical entity, such as a compound that binds to a target. The ligand can be isolated from natural or synthetically produced materials. Suitable ligands for the inventive method include, but are not limited to, amino acid and peptide sequences, as well as nucleic acids, antibody preparations (e.g. antibody fragments, chemically modified antibodies, and the like), carbohydrates, sugars, lipids, steroids, drugs, vitamins, cofactors, organic molecules, and combinations thereof. We have synthesized combinatorial libraries on the base matrix to produce ligands having between 1 and 6 amino acids that have been evaluated for binding of prion protein (PrPc and PrPsc) (see U.S. patent application Ser. No. 10/823,888).

In one embodiment, the ligands are synthesized on the surface of the support, which is advantageous in generating peptide libraries. The ligands can be chemically conjugated to the support or can be attached via linkers, such as beta-alanine, glycine, methionine, polymers containing glycine and serine, (—O—CH₂—CH₂-)n where n is between 1 and 30, polyethylene glycol, and epsilon amino caproic acid or combinations thereof. When the ligands are peptides, the amino acids used to synthesize the peptides on the support are preferably present in equimolar amounts.

Preferably the ligands are peptides. More preferably, the peptides consist essentially of about 2-15 amino acids. The term peptide as used herein refers to an entity comprising at least one peptide bond, and can comprise D and/or L amino acids. Ideally, the ligand is 3-10 amino acids. If desired, the peptide can be generated by techniques commonly employed in the generation of combinatorial libraries, e.g. the split, couple, recombine method or other approaches known in the art (Furka et al., Int. J. Peptide Protein Res. 37:487-493 (1991); Lam et al., Nature 354:82-84 (191); WO 92/00091; and U.S. Pat. Nos. 5,133,866, 5,010,175, and 5,498,538). Expression of peptide libraries is described by Devlin et al. (Science 249:404-406 (1990)). In peptide libraries, the number of discrete peptides of different sequences increases dramatically with the number of cycles of coupling reactions performed and the number of separate reactions per cycle. For example, the random incorporation of 18 amino acids into pentapeptides and an additional 17 amino acids at the N-terminal produces (18)(18)(18)(18)(18)(17) or 32×10⁶ individual peptides of differing sequence (see Lam et al., Nature 354:82-84 (1991)). Combinatorial methods allow synthesis of combinatorial libraries of ligands directly on a support. Typically the ligands are synthesized on particles of support media such that multiple copies of a single ligand are synthesized on each particle (e.g. bead), although this is not required in the context of the invention.

The combinatorial library may be modified by inclusion of other amino acids, e.g. aminodipic acid, beta-alanine, 2-aminobutyric acid, 6-amino caproic acid, citrulline, hydroxylysine, N-methylvaline, and norleucine. In addition, the combinatorial library may be modified by the insertion of phospho- and phosphonate adducts and analogs of certain amino acids including Ser, Thr and Tyr. Such reagents are available from Bachem, U.S., and other suppliers. In addition, the library may be modified post-synthesis by chemical or biochemical means. Examples of chemical modification include acetylation of amino groups with acetic anhydride, reaction with aziridines, epoxides, and methylglyoxal. Some modifications are the result of Maillard reactions and such products in tissue proteins are implicated in the pathology in aging, e.g. advanced glycation end-products and glyoxidation products such as N⁸-(carboxyethyl)lysine. Inclusion of these modifications assist in detecting biomarkers of disease and particularly exposure to toxins. Other modifications may be enzymatic through the action of protein kinases that phosphorylate serine, threonine and tyrosine, and glycosylases that glycosylate asparagine, serine and threonine.

Library synthesis usually proceeds in a serial fashion. In a preferred embodiment, coupling of the first amino acid uses a mixture of alkali-labile Fmoc-protected and acid-labile tBoc protected forms of alanine to control the density of the ligand on the resin. After coupling, the tBoc groups are removed with TFA and remaining free amino groups are acetylated. The Fmoc protecting group is then cleaved with piperidine, and the rest of the ligand is built with Fmoc-protected amino acids. In split, couple, and recombine synthesis, after coupling of the initial, density-determining amino acid, the resin is split into separate, multiple reaction vessels, each of which contains a different Fmoc-protected amino acid. Following coupling at the second position, (which blocks free amines), the completeness of which is assured by a negative ninhydrin reaction, the resin is collected from all of the reaction vessels, combined, and cleavage and deprotection of the entire mixture is performed in one reaction vessel. The resin is subsequently randomly subdivided again for coupling at the next position. This is repeated until peptides of the desired length are produced. Deprotection of the final Fmoc group is performed with piperidine and side-chain protecting groups are removed with TFA. Finally, the resin is thoroughly washed to remove all remaining reactants.

Ligand synthesis methods must be robust enough to ensure sufficient fidelity of synthesis. Parameters to be controlled include ensuring the appropriate density of initial coupling of the first amino acid, complete coupling of subsequent amino acids, adequate deprotection of Fmoc-blocked amino acids, and ensuring that full-length peptides are produced. Methods of measuring the success of coupling of amino acids during synthesis include measuring the level of unblocked amino groups using ninhydrin reagent and/or Kaiser test. Methods to determine the overall ligand synthesis include measurement of the expected ratios of amino acids by amino acid analysis, sequencing of selected beads by automated Edman degradation, and mass spectroscopy analysis of cleaved peptides.

A methionine residue may be introduced into the linker between the amino group and the first amino coupled for library generation. This has the added advantage in that it may be cleaved by cyanobromide to produce a homoserine residue at the carboxy terminal of the liberated peptide. By keeping the sub-libraries separate after the final coupling of the N-terminal using the D-amino acid it is possible to know both the end terminal groups on the cleaved ligand thereby aiding the sequencing of the ligand by mass spectrometry.

Target

For purposes of the present invention, the term “target” as used herein refers to any chemical, biochemical or biological entity, such as a molecule, compound, protein, virus, microparticle, or organelle, that is present in blood and binds to a ligand coupled to the support matrix of the invention. For example, the target can be a drug or drug candidate (such as a small molecule drug candidate), a toxin, an epitope-specific antibody or an infectious agent such as a bacterium, a fungus, or a parasite. Suitable targets for the inventive method include, but are not limited to, cells (be they eukaryotic (such as mammalian cells, e.g. stem cells or cells in culture, yeast cells and plant cells) or prokaryotic (such as bacterial cells and archaea cells)), viruses, microparticles, proteins, protein complexes and peptides, amino acids, nucleic acids, isoforms of any of the foregoing, and combinations of any of the foregoing. By isoforms it is intended to mean proteins, protein complexes, peptides, and nucleic acids that differ from the native protein, protein complex, peptide or nucleic acid. Such a difference can be structural, in which the primary sequence is the same, but the three-dimensional structure differs. Preferably, the targets are proteins. Suitable protein targets include, for example, receptors, antibodies, antigens, enzymes (e.g. proteases), detoxification proteins and mediators of inflammation, e.g. cytokines and C-reactive protein. More preferably, the proteins are found as the product of cellular breakdown, e.g. microparticles and other biomarkers of disease, e.g. alanine aminotransferase, lactate dehydrogenase, creatine kinase, troponin, pathogenic proteins such as antibodies to HLA and those involved in tissue rejection and infectious agents such as prion. In this regard, the plasma protein can be an infectious PrPsc prion protein.

Other proteins in blood include, for example, normal prion protein, proteases, epitope-specific antibodies, complement factors, fibrinogen, API, or coagulation factors, all of which are naturally found in the blood of an organism in a non-diseased state. Alternatively, the blood protein is present in plasma associated with a diseased state (optionally not found in the plasma of a healthy subject) or as a result of the administration of an agent, e.g. a drug.

One advantage of the inventive method is the ability to identify and/or characterize targets on the basis of chemical, biochemical and biological activity, without prior knowledge of the target's molecular identity. The chemical activity may be a mass spectral signal and the biochemical activity an enzyme activity such as a protease, organophosphatase, an inflammatory cytokine, etc. Accordingly the target can display a biological activity and need not undergo processing prior to practicing the inventive method.

Contact Conditions

The sample-containing targets may be mixed with the ligand-support complexes of the invention in one of several different formats well known in the art for binding targets to a support. These formats include chromatography column formats, batch addition of ligand-support complexes, monolithic structures, membranes and arrays. Standard column and batch formats are described in the parent applications. In addition, the combinatorial libraries may be interfaced with microfluidic sample handling systems to increase the concentration and recovery of trace analytes from complex mixtures via affinity library and affinity ligand beads to reduce sample loss and contamination. Further, it allows an interface with various forms of analytical equipment including, but not limited to electrospray ionization and MALDI mass spectrometry.

Dissociation of the Targets from the Ligands

In the context of the inventive method, at least a portion of the targets of the target-ligand-support-complexes may be dissociated from the ligand-support-complex. By eluting or dissociating at least a portion of the targets, it is meant that a percentage (or fragment) of any one specific target is eluted, since it is unlikely that 100% of the target bound to a specific bead could be transferred. Thus, by “at least a portion” it is meant that at least a percentage of the target of at least one target-ligand complex within the first matrix is transferred to the second matrix.

The dissociation is achieved through contacting the target-ligand-support complexes with a solution that promotes dissociation. The solution can be selected from buffers of known salt concentrations (2M NaCl), extremes of pH, or denaturing capability, e.g. strong chaotropes, e.g. 6M guanidine.HCl, organic solvents, de-ionized water. Alternatively, or in addition, an isoelectric gradient can dissociate the target from the ligand-support complex. Transfer solutions can also comprise ligands (different from the ligands on the ligand-support complexes), cofactors for the target, enantiomeric specific molecules, and the like. Use of different transfer solutions allow investigation of elution conditions and target sub-populations.

The dissociation conditions employed in the inventive method are selected to minimize disruption of the ligand from the support. In other words, the elution and transfer conditions should not release the ligand (or ligand-support complex) from the matrix (unless this is specifically desired).

Target Detection Methods

The inventive method further comprises detecting the dissociated targets that bind to the ligands of the ligand-support complexes. The term “detection” and words related thereto as used herein refer to the identification of any distinctive quality or trait of a target, and do not require that the precise chemical identities (e.g. the molecular formula, chemical structure, nucleotide sequence or amino acid sequence of the target) is elucidated. Furthermore, detection of multiple targets may be performed individually, sequentially or simultaneously. Alternatively, the targets can be detected by testing for a property or activity of the target, such as a biological property, chemical property, or a property that is a combination of any of the foregoing. The targets may be directly detected using, for example molecular weight by mass spectrometry or gel-electrophoresis, or spectral signal. Alternatively, the targets may be detected using immunological assays, for example, ELISA, Western blot and nephelometry assays. Otherwise, the targets may be detected by means of an enzyme assay such as a protease or organophosphatase that hydrolyses a fluorogenic substrate to create a fluorescent signal. On the other hand, the targets may be detected and analyzed by contacting cells with the eluted targets and detecting a cellular response using a biological assay such as cell growth, death, and differentiation. Additional techniques for detection and analysis are reviewed in Phizicky E M and Fields S. 1995, Protein-Protein Interactions: Methods for detection and Analysis, Microbiological Reviews, 59, (1) 94-123. See also the parent applications (U.S. patent application Ser. Nos. 10/414,523 and 10/601,032).

Pathogens including viruses may be bound to the ligands of combinatorial libraries (U.S. patent application Ser. No. 10/601,032) and detected by plaque formation around a bead binding the virus. The virus may alternatively be detected following binding to beads by the transfer onto a membrane and detection by nucleic acid probes that are complementary to the target sequence to which they hybridize. Probes may be radiolabelled or biotinylated. In the latter case, binding of the probe is visualized with streptavidin-alkaline phosphatase. We have demonstrated this for parvoviruses (data not shown). Alternatively the viruses can be eluted from the combinatorial library en masse and detected by means of either its infectivity in an appropriate assay, e.g. based on plaque formation in a susceptible cell line or by a nucleic acid amplification technique such as polymerase chain reaction. Using this method the virus can be concentrated, and substances that can interfere with PCR removed by washing thereby making diagnostic assays for viruses from complex samples such as whole blood, more sensitive. The product of the reaction may be analyzed by sequencing of the amplified nucleic acid to confirm the identity and isotype of the virus.

The targets can then be characterized as described in U.S. patent application Ser. Nos. 10/414,523, 10/601,032, 10/823,888, 10/727,335, 10/414,524, and 11/089,128, and Thulasiraman et al. (Electrophoresis 26(18):3561-3571 (2005)). In addition, the libraries of the invention are useful for the characterization of trace components present in final products. In addition, characterization of the target may also be performed following trypsin digestion of the target proteins while they are still immobilized on the ligand supports. The resulting peptides may be eluted from the supports and applied directly to a liquid chromatography resin for separation and then identified by mass spectrometry. A current favored method is two-dimensional liquid chromatography followed by tandem mass spectrometry. An alternative method involves the desorption of the protein followed by FT-ICR, MALDI or similar analyses.

Another method of analysis involves integration of elution of the beads with gel-electrophoresis. In a preferred embodiment the target-ligand support complexes are applied to a well of a one-dimensional SDS/LDS electrophoresis gel. Upon application of a voltage the targets will be electrophoresed into the polyacrylamide gel and resolved by molecular weight. This allows the power of separation according to three dimensional structure to be integrated with separation according to size. A further increase in resolution may be obtained through placing the target ligand supports in an isoelectric focusing gel and resolving the proteins by overall charge including pI and secondarily by molecular weight. The individual targets may be visualized by staining and their identity identified by orthogonal methods such as mass spectrometry.

### EXAMPLES

### Example 1

### Identification of Ligands to Various Targets Using Toyopearl Libraries

| | Sequence | Resin | Target | Source Material | Assay |
|---|---|---|---|---|---|
| A. | gVASED | Toyopearl | IL-2 | Conditioned | FIoNA cell |
| | | 650 M epoxy | | Cell medium | proliferation |
| B. | sSQXNK | Toyopearl | vWF | Plasma | Bead blot |
| | | 650 M amino | | | |
| C. | lGYTIA | Toyopearl | C-reactive | Whole blood | Bead blot |
| | | 650 M amino | protein | | |
| D. | lLDLFR | Toyopearl | Paraoxonase | Serum | FIoNA enzyme |
| | | 650 M epoxy | | | activity assay |
| E. | wHNPHY | Toyopearl | Sporadic | Plasma | Bead blot adapted |
| | | 650 EC amino | human PrP | | to structural |
| | | | | | isomers |

X=2′ naphthylalanine; small letters denote D amino acids; capital letters denote L amino acids

To be useful, the libraries described here must be appropriate for use with a wide variety of targets, source materials, and assays in which ligands can be identified. In Table 1, at least one example of each of the 18 natural amino acids and 2′naphtylalanine is represented by these hexamer ligands. Source materials included whole blood, plasma, and conditioned cell medium, and assays included the “bead blot” and identification of the ligand by functional, cell-based assays. The details of selection of each of these ligands and each of the assays used, is described below.

A. Identification of Ligands to IL-2

Complex cytokine mixtures have been screened for proteins that support the survival of NK-92 cells using a library of hexamer peptide ligands. A natural, secreted cytokine mixture derived from isolated lymphocytes and monocytes (ImmunoRx, Inc, Farmington, N.Y.) was used as a starting material. This mixture contained many cytokines that are released in response to biological induction and are not present in normal sera or culture media. The endpoints of this assay are both biological and fluorescent as described in Example 2. 11,000 beads from a hexamer library synthesized via a cysteine derivative on a backbone of Toyopearl 650-M epoxy beads (synthesized by Peptides International, Louisville, Ky.) were incubated with the cytokine mixture. The unbound and weakly bound proteins were removed by washing with PBS (150 mM NaCl, pH 7.4). 20-50 beads were incubated with 40 μl of NK-92 cells that had been plated at 2.4×10⁴ cells/ml in a well of a 384-well microtiter plate. The plates were maintained at 37° C. for 48 hrs. Approximately 30 clumps of growing cells were observed in 20 wells. In some cases a large clump of cells grew in close association with a bead. There were several beads in the immediate vicinity which had no cells growing near them, and significant patches of dead cells were indicated by propidium iodide (PI) uptake. One of these beads (and a few others from similar wells that supported growth) was collected and the presence of IL-2 on the beads was confirmed by modified antibody detection in a “bead blot” assay. Briefly, the beads are arrayed in agarose, the proteins transferred off the beads onto a PVDF membrane by capillary transfer in elution buffer, and the membrane probed with anti-IL-2 antibodies to detect IL-2. Eleven beads, including three potential positives were recovered, cleaned, re-incubated with the identical starting material and cultured individually with the same cell line. Two of three potential positive beads reconfirmed their activity in the deconvolution assay. An additional bead was sequenced and the associated ligand identified as the sequence GVASED. A resin with this ligand was synthesized and found to bind IL-2. The complete starting material will be fractionated on the resin and the bound proteins will be analyzed to identify additional proteins that may be purified on the resin and which contribute to the activity.

B. Identification of Ligands that Bind von Willebrand Factor

Briefly, 10 mg of library (˜2-3×10⁶ beads for M resin) were incubated with 1 ml thawed, pooled human plasma diluted with an equal volume of EQ Buffer for one hour at room temperature with agitation. The beads were drained, and washed with 10 column volumes of EQ buffer. The beads were resuspended in 1 ml EQ Buffer. 10 μl of beads were combined with 90 μl of low melting point agarose and spread across an agarose base. The transfer proceeded for 16 hours at room temperature in 2M NaCl, 20 mM NaCitrate pH 7.4. vWF on the membrane was detected with a horseradish peroxidase (HRP)-labeled anti-vWF monoclonal antibody (Enzyme Research Labs Serotec, Raleigh, N.C.). Beads that aligned with the spots were selected, washed, re-incubated with plasma and the transfer and detection repeated as described above. Other beads were selected using I¹²⁵ labeled anti-vWF monoclonal antibody. Several sequences were identified (Hammond et al, U.S. Provisional Patent Application No. 60/372,091) and affinity resins baring the identified ligands were synthesized at a gram scale. After incubation with plasma, several beads were placed in wells of a 96-well microtiter plate and incubated with a FVIII chromogenic assay kit (Chromogenics, Mølndal, Sweden). Beads that bound FVIII were identified by yellow color in the wells, the intensity of which was the deciding factor for determining quality of Factor VIII binding. For determination of the level of purification of vWF, a 1 ml column of resins that bound both vWF and Factor VIII was exposed to 20 ml human plasma on an Akta Explorer (Amersham Biosciences, Piscataway, N.J.). Proteins were eluted and vWF binding to the resin was detected by Western blot.

C. Identification of Ligands to C-Reactive Protein

Each bead has multiple copies of a single ligand, and different beads will have different ligands. A library of hexamer peptide ligands, synthesized on Toyopearl 650 M amino library (Tosoh Biosciences, Montgomeryville, Pa.) by Peptides International, (Louisville, Ky.) and using all of the natural amino acids with the exception of Met, Cys and Gln at the N-terminal position, and with addition of 2′ naphthylalanine, was swollen and equilibrated in CPD solution (citrate, phosphate dextrose solution; product of Macopharma of Lille, France) and diluted 1:7 in phosphate buffered saline, pH 7.4 (140 mM NaCl). 500 μl aliquots of swollen, equilibrated library were dispensed into 10 ml Polyprep chromatography columns (Bio-Rad, Hercules, Calif.). Human CRP (Novagen, San Diego, Calif.) was spiked into 5 ml citrated whole blood a final concentration of 100 ng/ml. The spiked blood was incubated with the equilibrated library for 1 hour at room temperature, with rotation. Plasma proteins, including CRP, will bind to their corresponding ligands through affinity interactions.

After incubation, the unbound fraction was drained by gravity and the column was washed with 5 ml diluted CPD plus 0.05% Tween-20 (Sigma-Aldrich, St Louis, Mo.), followed by 2×5 ml diluted CPD. This produced the washed “loaded” library.

Bead blots were prepared by adding 10 μl of the blood library containing approximately 25,000 beads, along with 2-3 μl of alignment beads, to 100 μl 0.5% low melting point agarose. Each mixture was poured on top of a 10 ml, 1.0% agarose gel (Pierce).

Alignment beads were used to improve identification and selection of CRP binding beads. Protein G sepharose beads were non-covalently bound with mouse IgG. This was detected by subsequent incubation with alkaline-phosphatase-labeled goat anti-mouse IgG (Pierce Biotechnology, Rockford, Ill.). The alignment beads generated a signal by forming a red precipitate on the beads upon incubation with chromogenic alkaline phosphatase substrate Fast-Red (Sigma-Aldrich, St. Louis, Mo.).

The gel was placed on a wick extending into a tank of transfer buffer. A PVDF membrane was placed on top of the gel, facing the beads, so that the bound proteins were transferred overnight by capillary action with transfer buffer and captured on the membrane. During transfer, the transfer buffer permeates through the gel and the membrane and in the process dissociates bound protein from the beads according to the strength of the affinity interaction and the composition of the transfer buffer. A variety of transfer conditions and transfer buffers may be used. To transfer high affinity ligand, strong chaotrope, such as 6M guanidine, is employed.

Upon removal of the membrane from the gel, the location of beads that had bound either mouse IgG from alignment beads or human CRP from loaded library was determined by detecting the presence of CRP using mouse anti-human CRP antibody (Sigma-Aldrich, St Louis, Mo.), followed by alkaline phosphatase labeled goat anti-mouse IgG secondary antibody (Pierce Biotechnology, Rockford, Ill.). This produced a film with spots indicating the position of detected protein(s). The film and the gel were superimposed and the spots aligned with beads, the majority of which were red alignment beads. White beads associated with spots indicated potential CRP ligands. These beads were selected, and their ability to bind CRP was confirmed by re-equilibrating and re-incubating the beads with CRP in blood or plasma.

The experiments were repeated twice. Two beads from the spiked blood and six beads from the spiked plasma, respectively, were selected. Ligand sequencing was performed by automated Edman degradation using a Procise 494 protein sequencer, product of Applied Biosystems. A sequence derived from the beads from the spiked whole blood was Leu-Gly-Thr-Tyr-Ile-Ala.

D. Identification of Ligands to Paraoxonase

Ligands to paraoxonase were identified using enzymatic hydrolysis of a proprietary substrate. 1 ml of human serum was incubated with epoxy library for one hour at room temperature with rotation. The resins were washed with 10 column volumes of citrate buffer (CB-20 mM citrate, 140 mM NaCl, pH 7.4). Washed resin was re-suspended in 18 ml TC buffer (150 mM NaCl, 110 mM pH 8.0, 2 mM CaCl₂). The fluorescent substrate is described in and custom synthesized by Molecular Probes, Inc. (Eugene, Oreg.). DEPFMU was added to 50 μM final concentration, and the beads distributed at about 1 bead per well in four 100,000-well plates (Diversa, Inc, San Diego, Calif.). Fluorescence was monitored in a Diversa GigaMatrix™ plate reader (Diversa) and beads from selected wells were recovered robotically. To confirm the specific binding of plasma OPase to the peptide resins, the peptide resins were incubated with 1 ml of plasma. Non-bound proteins were removed by washing with 20 mls of PBS. Resin pellets were suspended in TC buffer and OPase bound activity was evaluated using DEPFMU as substrate as described above. Several ligands were discovered, including one with the sequence leu-Leu-Asp-Phe-Leu-Arg. Thus, ligands from this library can be selected for binding an active protein using enzymatic activity as the selection assay.

E. Method for Detecting Prion Protein (PrP)

This method can be used to identify ligands that bind to proteins involved in disease. These ligands may potentially be used to diagnose the presence of the target in various complex mixtures, or to remove the disease-causing protein from mixtures. In the example described below, the invention was used to identify ligands that bind to Prion protein, a protein associated with transmissible spongiform encephalopathies.

5 mg of a library synthesized on Toyopearl Amino 650 EC resin, which have a diameter of 100-300 μm beads, resin beads bearing ligands that were two amino acids long was blocked with 1% w/v casein for 18 hours at 4° C. with rocking. Sporadic CJD human brain homogenate diluted 1:10 with PBS was incubated with 0.5% w/v sarkosyl for 30 minutes. 1 ml of a 1:10 dilution of the treated material was spiked into human plasma (diluted 1:1 with 20 mM citrate/140 mM NaCl, pH 7.4) and incubated with the blocked beads for one hour at 22° C. with rocking. 90 μl of the beads were mixed with 800 μl of 0.5% LMP agarose and poured over a base of 9 ml of 1% agarose and allowed to harden at 4° C. for approximately 15 minutes. The transfer was set up as previously described onto PVDF membrane using 6M GuHCl as the transfer buffer, and allowed to proceed overnight. Following transfer the membrane was separated from the gel, blocked with 5% milk, and prion protein detected with 3F4, an antibody specific for the denatured form of PrPc, as the primary antibody. An HRP-labeled goat anti-mouse secondary antibody was used with an enhanced chemiluminescent substrate to detect spots on the membrane that had bound PrPc and the signal was captured on X-ray film. The films were aligned with the gel, and beads that aligned with spots on the film were picked, washed, and sequenced.

F. Amino Acid Analysis—

To confirm that the libraries were synthesized correctly, with the appropriate representation of the required amino acids, amino acid analysis (AAA) is performed by the manufacturer, using Accq-Tag (Waters) reagents for pre-column derivatization and acid hydrolysis followed by RP-HPLC. Because N and Q are hydrolyzed to D and E, the relative ratios for D and E are 2× what they should be in a library. W decomposes completely under acid hydrolysis, and is not detected. S, T, Y oxidize during hydrolysis are therefore underrepresented. Typical results for a library therefore are: Asp (1.74), Ser (0.43), Glu (1.69), Gly (1.62), His (0.88), Arg (0.68), Thr (0.59), Pro (0.94), Tyr (0.75), Val (1.10), Aca (3.17), Lys (0.89), Ile (0.77), Leu (1.06), Phe (1.00), Ala (present, not determined), Nal(2′) (present, not determined), and Trp (not determined).

### Example 2

### Acetylated Resin

Defined alterations to the standard library result in advantageous differences in the performance of the library in terms of its ability to enrich for certain proteins. In this example, the library was acetylated, which removes the positive charge from the N-terminal amino acid and from the primary amine in lysine.

An aliquot of the library described here was completely acetylated by incubation with triethylamine and acetic anhydride. Aliquots of acetylated and non-acetylated library were swollen, washed and equilibrated with diluted CPD (Baxter Healthcare, Deerfield, Ill.). 100 μl of each was aliquoted into BioRad columns. 1 ml of diluted, leukoreduced, platelet-poor plasma was added to each column and incubated at ambient temperature for 1.5 hr, rotating. The non-bound protein was removed by gravity and washing. 50 μl aliquots of the resin were removed from each column and heated at 70° C. for 10 minutes in 2×LDS buffer. The starting material was diluted 1:50, the samples diluted 1:1, and 10 μl of each was loaded into the lanes of a 4-12% Bis-Tris gel (Invitrogen, Carlsbad, Calif.). The gel was electrophoresed at 200 V until dye front reached the bottom, about 50 minutes. The proteins were visualized by staining with SimplyBlue (Invitrogen) according to the manufacturer's microwave protocol.

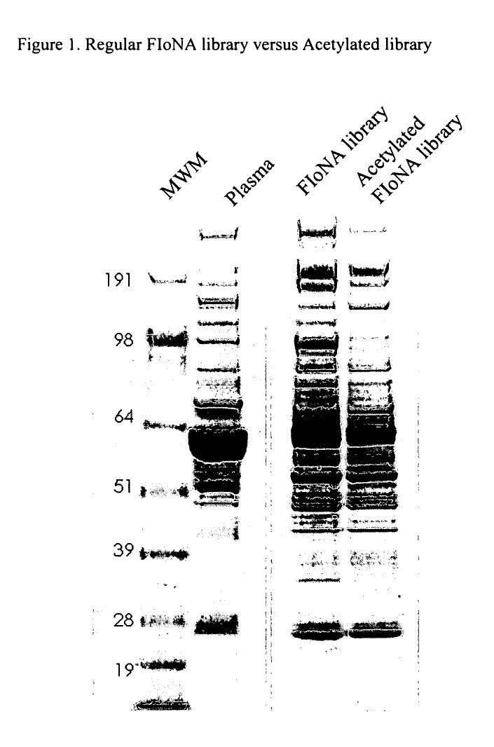

The results are presented in FIG. 1. There are differences in the intensity of some of the protein bands between the untreated library and the acetylated library, indicating that acetylation alters the binding of some proteins to the library. These defined adaptations of the library can be combined to produce a library with the most diverse binding profile possible.

### Example 3

### Special Ligands—Cleavable Linker and Branched Ligands

One of the benefits of a chemical rather than a biological library is that un-natural amino acids (such as 2′-naphthylalanine, present in sequences above) can be included in the library. Other adaptations include synthesis of libraries with cleavable linkers so the ligands can be liberated and sequenced by mass spectrometry, or with branched ligands to increase the diversity. We have produced libraries on TentaGel and Toyopearl Epoxy resin containing methionine in the position after the glycine (TentaGel) or alanine (Toyopearl) linker, followed by combinatorial synthesis of the remaining hexamer ligand. The Met was cleaved by incubating the resin with cyanogen bromide. Libraries were also synthesized with a Lys attached to a cleavable Met, which was attached to the standard Ala for ligand density control. Because the Lys side chain has a primary amine, hexamers can be synthesized off both the primary amine of the peptide backbone and the amine of the Lys, thereby generating a branched ligand.

### Example 4

### Direct Elution of Protein from Beads by Electrophoresis

A further extension of the use of the libraries is their incorporation into a device complete with elution of the bound proteins directly into a system for their analysis. A possible set-up would include elution of the bound proteins by placing the beads directly into wells of a gel and electrophoresing the proteins into the gel. This experiment was designed to demonstrate that this was feasible.

Proteins from a conditioned cell medium were loaded onto beads of a library synthesized on Toyopearl Amino 650 M resin that had been equilibrated in PBS (Invitrogen). 1 ml of library was incubated with 100 ml conditioned medium for 1.5 hours at ambient temperature, with rotating. The non-bound proteins were washed off with PBS. 2.5 μl of beads with bound proteins were loaded into a well of a 4-12% BisTris SDS-PAGE gel, along with other samples prepared as described, but with proteins eluted from the beads by 10 mM acetate buffer, pH 4 (neutralized by 10 mM NaHCO₄ buffer) twice. Proteins were visualized by Silver staining.

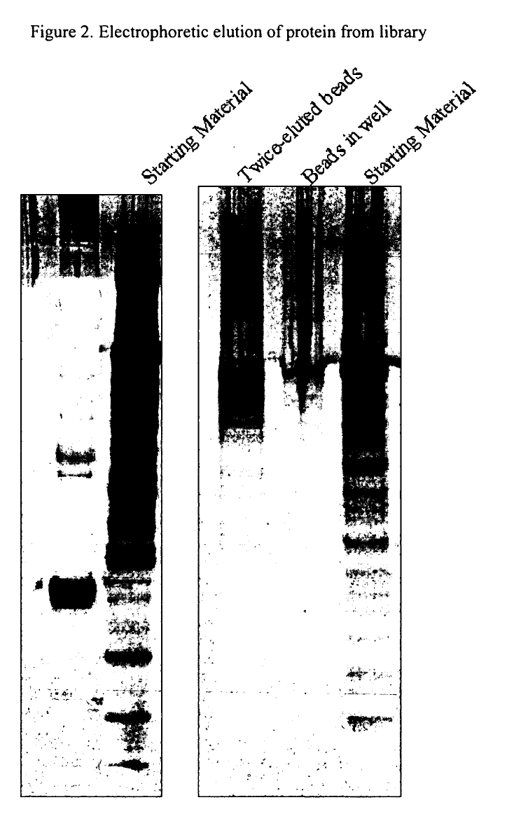

The results are presented in FIG. 2. The far right lane has protein bands, indicating that protein was directly eluted from the beads by electricity, rather than by elution buffer. These data indicate that incorporating loaded beads into a system that uses total electrophoretic elution of bound proteins is feasible.

### Example 5

### Use of Libraries on Nanoparticles-Sonicated Resin

Because some samples may be present in limited volumes, it will be useful to retain the diversity of the library in a smaller volume. This can be accomplished by reducing the size of the beads, by synthesizing the library on a smaller resin, or by decreasing the size of the beads in an existing library by crushing, milling, or sonicating the beads. This experiment demonstrates that sonicated beads can be used as a FIoNA library to treat serum.

The size of the resin in 100 μl Amino Toyopearl library was decreased by adding 600 μl 1×PBS to yield total 700 μl volume and sonicated (model VC-505 sonicator, Sonics, Inc) for 30 seconds at 10 second intervals, each with 1 second pause. The sonicated beads are reduced to less than 1 μm in size. 100 μl of whole beads were prepared and set aside. Both batches of beads were equilibrated with citrate. Each was incubated with 900 μl de-lipidated human serum (Sigma-Aldrich, St. Louis, Mo.) for one hour, ambient temperature, with rotation.

Each tube was centrifuged at 14,000 rpm for 1 minute to pellet the resin and the unbound material was retained. The resins were washed by vortexing (vigorously for the crushed, very lightly for the whole beads) and centrifuging at 14,000 rpm for 1 minute with 1 ml citrate buffer (20 mM sodium citrate, 140 mM sodium chloride, pH=7). The first 1 ml of wash was saved. Each batch was washed with additional 4×500 μl citrate.

All the resin from each batch was incubated with 200 μl 6M GuHCl, for 1 hour in batch format, with tumbling. The samples were centrifuged at 14,000 rpm for 1 minute. The supernatant was collected for analysis and kept at room temperature. The starting material and washes were diluted 1:25 with citrate, then 1:2 with 2×LDS/DTT. The resulting dilution of serum was 1:50. All were heated 10 min, at 90° C. and then froze at 20° C. 6M GuHCl in the eluates was exchanged to 1M urea G-25 columns (The Nest group, Inc). 1 M urea samples were heated with LDS/DTT, for 10 min, at 90° C. (14 μl sample+5 μl of 4×LDS+2 μl of 10×DTT) and the samples stored o/n at −20° C. 20 μl of the re-heated samples were loaded into wells of a 4-12% BisTris gel. Run with MOPS running buffer (Invitrogen, Carlsbad, Calif.) at 200 V until front dye reached the bottom of gels (approximately 50 minutes). Proteins were visualized by staining with SimplyBlue (Invitrogen).

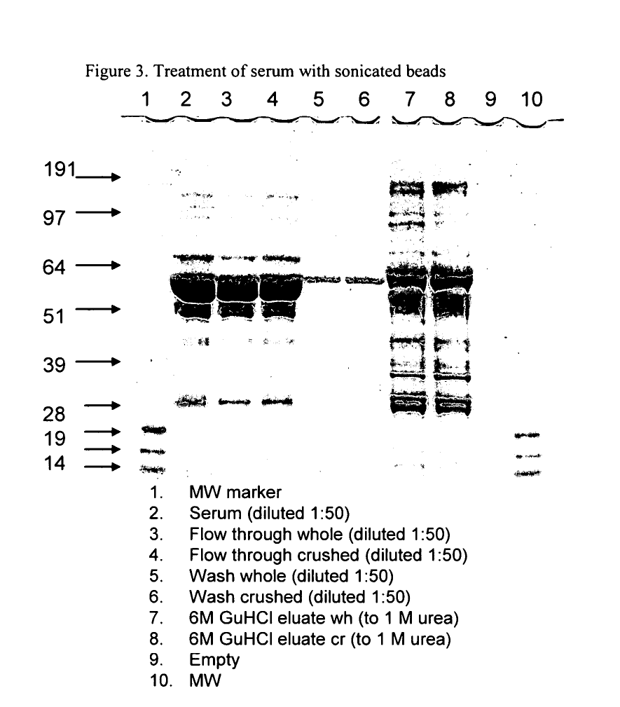

The results are presented in FIG. 3. Lanes 7 and 8 compare the protein pattern of whole and sonicated beads, respectively. There was no decrease or obvious change in the performance of the resin when the beads were decreased in size; therefore, the diversity and binding capabilities were maintained. This method can be adapted to use a smaller volume of resin with a small sample size.

### Example 6

### Protein-Binding Capacity of Ligands and Library

The total amount of protein captured by the library can determine if a trace protein can be enriched to a concentration greater than the limit of detection of a particular analytical technique. Thus, it is important that the resin possess sufficient protein-binding capacity. This has been demonstrated with ligands that bind cross-linked bovine hemoglobin.

The ligands were identified by direct on-bead detection of cross-linked bovine hemoglobin to a library of ligands synthesized on Toyopearl Amino 650 M resin. The total protein binding capacity was determined by Langmuir, equilibrium isotherms, in which a constant volume of resin is incubated with increasing concentrations of target protein. 50 μl aliquots of the ligand ySYTAY (small letter denotes D-amino acid. Capital letters denote L-amino acids) were incubated with bovine hemoglobin spiked into 400 μl PBS at increasing concentration. The level of binding of the resin was determined by measuring absorbance of the unbound material at 405 nm. The capacity of the ligand for the target was determined to be 25 mg hemoglobin per ml swollen resin, indicating greater capacity than mere surface binding, which can be beneficial to enriching for trace proteins.

### Example 7

### Analysis of Bound Protein by Mass Spectroscopy

In order for these libraries to have the maximum value to proteomic analysis, the proteins captured must be suited to a variety of analytical techniques. Previous examples have demonstrated ligand identification by bead blot and activity assays. Much proteomic work is done by evaluating bound proteins by mass spectrometry. The purpose of this experiment is to evaluate proteins captured by the resin using mass spectrometry.

Plasma was incubated at a 1:10 ratio of plasma to hexamer library synthesized on Toyopearl Amino 650M that had been equilibrated in citrate buffer for one hour at ambient temperature, with rotating. Nonbound proteins were washed off with 20 column volumes citrate buffer. Total protein was eluted with low pH buffer (xxx). The entire eluate was digested with trypsin (Promega, Madison, Wis.) and analyzed by Mass spectrometry using an LCQ-DECA XP instrument (ABI, Foster City, Calif.). 81 proteins with priority scores greater than 5000 were identified (priority scores are a way of determining the likelihood that a particular sequence identification is in fact correct and are a combination of the number of peptides identified, the quality of the match by sequence identification software (Turbo Seaquest in this instance) and other factors; a score greater than 5000 is generally considered reliable).

1. A solid-phase combinatorial peptide library, comprising inert supports having synthesized thereon a combinatorial peptide library, wherein the combinatorial peptide library comprises one thousand or more different peptide ligands.

2. The solid-phase combinatorial peptide library of claim 1, wherein said peptide ligands have a density in the range of 100 to 400 μmoles per gram dry weight of resin.

3. The solid-phase combinatorial peptide library of claim 1, wherein said peptide ligands are about 2-15 amino acids in length.

4. The solid-phase combinatorial peptide library of claim 3, wherein said peptide ligands are about 3-10 amino acids in length.

5. The solid-phase combinatorial peptide library of claim 1, wherein the peptide ligands are comprised of amino acids selected from the group consisting of L-amino acids, with the exception of cysteine and methionine, D-amino acids, amino-dipic acid, beta-alanine, 2-aminobutyric acid, 6-amino caproic acid, citrulline, hydroxylysine, N-methylvaline, norleucine, and phospho- and phosphonate adducts and analogs of serine, threonine, and tyrosine.

6. The solid-phase combinatorial peptide library of claim 5, wherein the peptide ligands are comprised of amino acids selected from the group consisting of L-amino acids, D-amino acids, citrulline, and phospho- and phosphonate adducts and analogs of serine, threonine, and tyrosine.

7. The solid-phase combinatorial peptide library of claim 5, wherein said amino acids are present in equimolar amounts.

8. The solid-phase combinatorial peptide library of claim 1, wherein an amino group is coupled to the inert support prior to synthesizing the peptide ligands thereon.

9. The solid-phase combinatorial peptide library of claim 8, wherein a linker is attached to said amino group, and the peptide ligands are synthesized onto the linker.

10. The solid-phase combinatorial peptide library of claim 9, wherein said linker is selected from the group consisting of epsilon amino caproic acid and methionine.

11. The solid-phase combinatorial peptide library of claim 1, wherein said peptide ligands are modified by chemical or biochemical means.

12. The solid-phase combinatorial peptide library of claim 11, wherein said chemical means is selected from the group consisting of acetylation of amino groups with acetic anhydride, reaction with aziridines, reaction with epoxides, and reaction with methylglyoxal.

13. The solid-phase combinatorial peptide library of claim 1, wherein said peptide ligands are enzymatically modified by an enzyme selected from the group consisting of a protein kinase and a glycosylase.

14. The solid-phase combinatorial peptide library of claim 1, wherein said inert support is selected from the group consisting of membranes, filters, meshes, beads and particles comprised of or coated with a material selected from the group consisting of resin, agarose, cellulose, dextran, ethylene glycol, fluoropolymers, polyacrylate, polyesters, polyethylene glycol, methacrylate, hydroxymethacrylates, glycidol methacrylate, ethylene glycol dimethacrylate, pentaerytritol dimethacrylate, dimethacrylate, polyhydroxylated methacrylate polymer, methacrylate monomer, polypropylene, polyethylene oxides, short chain hydrocarbon-oxide spacers leading to —CH₂—CHOH—CH₂—NH₃, polysaccharide derivatives of any of the foregoing and combinations of the foregoing.

15. The solid-phase combinatorial peptide library of claim 14, wherein said inert support is selected from the group consisting of membranes, filters, meshes, beads and particles comprised of or coated with a material selected from the group consisting of polyethylene glycol, methacrylate, hydroxymethacrylates, glycidol methacrylate, ethylene glycol dimethacrylate, pentaerytritol dimethacrylate, dimethacrylate, polyhydroxylated methacrylate polymer, methacrylate monomer, polypropylene, polyethylene oxides, short chain hydrocarbon-oxide spacers leading to —CH₂—CHOH—CH₂—NH₃, and combinations of the foregoing.

16. The solid-phase combinatorial library of claim 14, wherein said inert support is a polyhydroxylated methacrylate based polymer.

17. The solid-phase combinatorial library of claim 14, wherein said inert support is a bead comprised of a resin.

18. The solid-phase combinatorial library of claim 17, wherein said resin bead is a Toyopearl AF-Amino 650M bead.

19. The solid-phase combinatorial library of claim 17, wherein said resin bead is macroporous.

20. The solid-phase combinatorial library of claim 19, wherein said macroporous resin bead has a pore size of about 100 nm.

21. The solid-phase combinatorial library of claim 17, wherein said resin bead is about 300 μm or larger in diameter.

22. The solid-phase combinatorial library of claim 17, wherein said resin bead is about 65 μm or larger in diameter.

23. The solid-phase combinatorial library of claim 17, wherein said resin bead is 10 μm or less in diameter.

24. The solid-phase combinatorial library of claim 17, wherein said resin bead is about 1 μm or less in diameter.

25. A method for preparing a solid-phase combinatorial library comprising:
coupling amino groups to inert supports;
attaching spacers to said amino groups; and
synthesizing peptide ligands on said spacers.

26. The method of claim 25, wherein said solid-phase combinatorial library comprises one thousand or more different peptide ligands.

27. The method of claim 25, wherein said peptide ligands have a density in the range of 100 to 400 μmoles per gram dry weight of resin.

28. The method of claim 25, wherein said peptide ligands are about 3-10 amino acids in length.

29. The method of claim 25, wherein the peptide ligands are comprised of amino acids selected from the group consisting of L-amino acids, with the exception of cysteine and methionine, D-amino acids, amino-dipic acid, beta-alanine, 2-aminobutyric acid, 6-amino caproic acid, citrulline, hydroxylysine, N-methylvaline, norleucine, and phospho- and phosphonate adducts and analogs of serine, threonine, and tyrosine.

30. The method of claim 29, wherein the peptide ligands are comprised of amino acids selected from the group consisting of L-amino acids, D-amino acids, citrulline, and phospho- and phosphonate adducts and analogs of serine, threonine, and tyrosine.

31. The method of claim 29, wherein the amino acids are provided in equimolar amounts.

32. The method of claim 25, wherein said spacer is selected from the group consisting of epsilon amino caproic acid and methionine.

33. The method of claim 25, wherein said peptide ligands are modified by chemical or biochemical means.

34. The method of claim 33, wherein said chemical means is selected from the group consisting of acetylation of amino groups with acetic anhydride, reaction with aziridines, reaction with epoxides, and reaction with methylglyoxal.

35. The method of claim 25, wherein said peptide ligands are enzymatically modified by an enzyme selected from the group consisting of a protein kinase and a glycosylase.

36. The method of claim 25, wherein said inert support is selected from the group consisting of membranes, filters, meshes, beads and particles comprised of or coated with a material selected from the group consisting of resin, agarose, cellulose, dextran, ethylene glycol, fluoropolymers, polyacrylate, polyesters, polyethylene glycol, methacrylate, hydroxymethacrylates, glycidol methacrylate, ethylene glycol dimethacrylate, pentaerytritol dimethacrylate, dimethacrylate, polyhydroxylated methacrylate polymer, methacrylate monomer, polypropylene, polyethylene oxides, short chain hydrocarbon-oxide spacers leading to —CH₂—CHOH—CH₂—NH₃, polysaccharide derivatives of any of the foregoing and combinations of the foregoing.

37. The method of claim 36, wherein said inert support is selected from the group consisting of membranes, filters, meshes, beads and particles comprised of or coated with a material selected from the group consisting of polyethylene glycol, methacrylate, hydroxymethacrylates, glycidol methacrylate, ethylene glycol dimethacrylate, pentaerytritol dimethacrylate, dimethacrylate, polyhydroxylated methacrylate polymer, methacrylate monomer, polypropylene, polyethylene oxides, short chain hydrocarbon-oxide spacers leading to —CH₂—CHOH—CH₂—NH₃, and combinations of the foregoing.

38. The solid-phase combinatorial library of claim 36, wherein said inert support is a polyhydroxylated methacrylate based polymer.

39. The solid-phase combinatorial library of claim 36, wherein said inert support is a bead comprised of a resin.

40. The solid-phase combinatorial library of claim 39, wherein said resin bead is a Toyopearl AF-Amino 650M bead.

41. The solid-phase combinatorial library of claim 39, wherein said resin bead is macroporous.

42. The solid-phase combinatorial library of claim 41, wherein said macroporous resin bead has a pore size of about 100 nm.

43. The solid-phase combinatorial library of claim 39, wherein said resin bead is about 100 to 300 μm or larger in diameter.
